(19) United States
(12) Patent Application Publication
(10) Pub. No.: US 2025/0012619 A1
(43) Pub. Date: Jan. 9, 2025

(54) ACOUSTIC BALANCE: WEIGHING IN ULTRASONIC NON-CONTACT MANIPULATORS

(71) Applicant: University of Washington, Seattle, WA (US)

(72) Inventors: Joshua R. Smith, Seattle, WA (US); Jared Nakahara, Seattle, WA (US)

(73) Assignee: University of Washington, Seattle, WA (US)

(21) Appl. No.: 18/763,337

(22) Filed: Jul. 3, 2024

Related U.S. Application Data
(60) Provisional application No. 63/512,559, filed on Jul. 7, 2023.

(51) Int. Cl. G01G 5/00; G01G 23/01; G01G 23/06; G01N 29/22

(52) U.S. Cl. CPC G01G 5/00; G01G 23/01; G01G 23/06; G01N 29/221

(57) ABSTRACT

Acoustic balances configured for weighing in ultrasonic non-contact manipulators, and associated systems and methods are described. In one embodiment, a method for a non-contact acoustic determination of a mass of an object includes capturing the object within an acoustic trap of an acoustic balance. The method also includes, in response to changing at least one acoustic parameter of the acoustic balance, changing an equilibrium position of the object; and in response to changing the equilibrium position of the object, causing the object to oscillate. The method also includes determining a resonant frequency of oscillation of the object; and based on the resonant frequency of oscillation of the object, determining the mass of the object.

### CROSS-REFERENCE TO RELATED APPLICATION

This application claims the benefit of U.S. Provisional Application No. 63/512,559, filed Jul. 7, 2023; the entire disclosure of which is hereby incorporated by reference.

### STATEMENT OF GOVERNMENT LICENSE RIGHTS

This invention was made with government support under Grant No. NSF 2024435, awarded by the National Science Foundation. The government has certain rights in the invention.

### BACKGROUND

Robots have become increasingly capable of dexterous manipulation, typically achieved by arm and manipulator designs with high degrees of freedom, accurate object pose estimation, sophisticated motion planning and motor skills. However, most general purpose robots' dexterities are limited to manipulating larger objects on the scale of centimeters or above, lacking the ability to perform the same level of manipulation on smaller objects. With limited gripping force resolution and positioning accuracy, these robots can miss or damage the target object in cases when the object of interest is small or fragile. However, millimeter-scale manipulation is a skill required for daily life, scientific research, and in the manufacturing industry. For example, in biology, neural science, and other related research areas, experiments that involve handling small, deformable and fragile objects like insects, biological tissues, and drops of fluid are very common. Similarly, objects like bare silicon dyes and electronic components used in micro assembly and PCB manufacturing industries also need an extra level of caution and precision because of their size and fragility. The increasing need to automate these experiments and manufacturing processes in these fields highly motivates further research into enabling general purpose robots to manipulate millimeter-scale objects. Often, mass of an object has to be determined for the subsequent proper handling of the object.

Accordingly, systems and methods for handling and weighing of small objects are still needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Briefly, the inventive technology is directed to acoustic traps and levitation systems can lift, translate and manipulate a wide range of objects and materials without contact. This enables new manipulation capabilities for robots that may not be possible otherwise. The inventive technology is further directed to a contactless method for weighing acoustically trapped objects in air using an acoustic balance. The method works by measuring a step response of the trapped object. That is, the system commands a change in the phase of the acoustic emitters, which results in a sudden change in the equilibrium position of the trap. In response, the object held within the acoustic trap undergoes damped oscillation as it settles into the new equilibrium point. The mass of the trapped object can be determined from the frequency of oscillation. Combined with methods for adding and merging materials in the trap, the method presented here can potentially enable a robot to operate a closed loop process to acquire or maintain a desired quantity of material. For example, using weight as an error signal, material could be added by the acoustic system until the required quantity is in the trap.

In one embodiment, a method for a non-contact acoustic determination of a mass of an object includes capturing the object within an acoustic trap of an acoustic balance. In response to changing at least one acoustic parameter of the acoustic balance, an equilibrium position of the object is changed. In response to changing the equilibrium position of the object, the object oscillates. The method also includes determining a resonant frequency of oscillation of the object; and based on the resonant frequency of oscillation of the object, determining the mass of the object.

In one embodiment, an apparatus for non-contact manipulation of an object includes ultrasound transducers configured for generating an ultrasound field. The apparatus also includes a controller configured to generate phase delay signals for the array of ultrasound transducers. The ultrasound field is configured for: capturing the object within an acoustic trap of an acoustic balance; in response to changing at least one acoustic parameter of the acoustic balance, changing an equilibrium position of the object; and in response to changing the equilibrium position of the object, causing the object to oscillate. The controller is configured for: determining a resonant frequency of oscillation of the object; and based on the resonant frequency of oscillation of the object, determining the mass of the object.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, where:

FIG. 1 is an isometric drawing of a system for weighing objects via ultrasonic levitation in accordance with an embodiment of the present technology;

FIG. 2 is a cross-sectional side view of an acoustic balance in accordance with an embodiment of the present technology;

FIG. 3 is a top view of the acoustic balance shown in FIG. 2;

FIGS. 4A-4F are example objects subjected to weighing in accordance with an embodiment of the present technology;

FIGS. 5A and 5B are graphs of object displacement in accordance with an embodiment of the present technology;

FIG. 6 is a flowchart of a method for non-contact determination of mass of objects in accordance with an embodiment of the present technology; and

FIG. 7 is a graph of object mass determined in accordance with an embodiment of the present technology.

### DETAILED DESCRIPTION

While illustrative embodiments have been illustrated and described, it will be appreciated that various changes can be made therein without departing from the spirit and scope of the invention.

Before explaining at least one embodiment of the presently disclosed and/or claimed inventive concept(s) in detail, it is to be understood that the presently disclosed and/or claimed inventive concept(s) is not limited in its application to the details of construction and the arrangement of the components or steps or methodologies set forth in the following description. The presently disclosed and/or claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the presently disclosed and/or claimed inventive concept(s) have been described in terms of preferred embodiments, it will be apparent to those skilled in the art that variations may be applied to the articles and/or methods and in the steps or in the sequence of steps of the method described herein without departing from the concept, spirit, and scope of the presently disclosed and/or claimed inventive concept(s).

As utilized in accordance with the present disclosure, the following terms, unless otherwise indicated, shall be understood to have the following meanings.

The use of the word “a” or “an” when used in conjunction with the term “comprising” may mean “one”, but it is also consistent with the meaning of “one or more”, “at least one”, and “one or more than one”. The use of the term “or” is used to mean “and/or” unless explicitly indicated to refer to alternatives only if the alternatives are mutually exclusive, although the disclosure supports a definition that refers to only alternatives “and/or”. Throughout this application, the term “about” is used to indicate that a value includes the inherent variation of error for the quantifying device, the method being employed to determine the value, or the variation that exists among the study subjects. For example, but not by way of limitation, when the term “about” is utilized, the designation value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and is not meant to imply any sequence or order or importance to one item over another or any order of addition, for example.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

In the context of this disclosure, the terms “about,” “approximately,” “generally” and similar mean ±5% of the stated value.

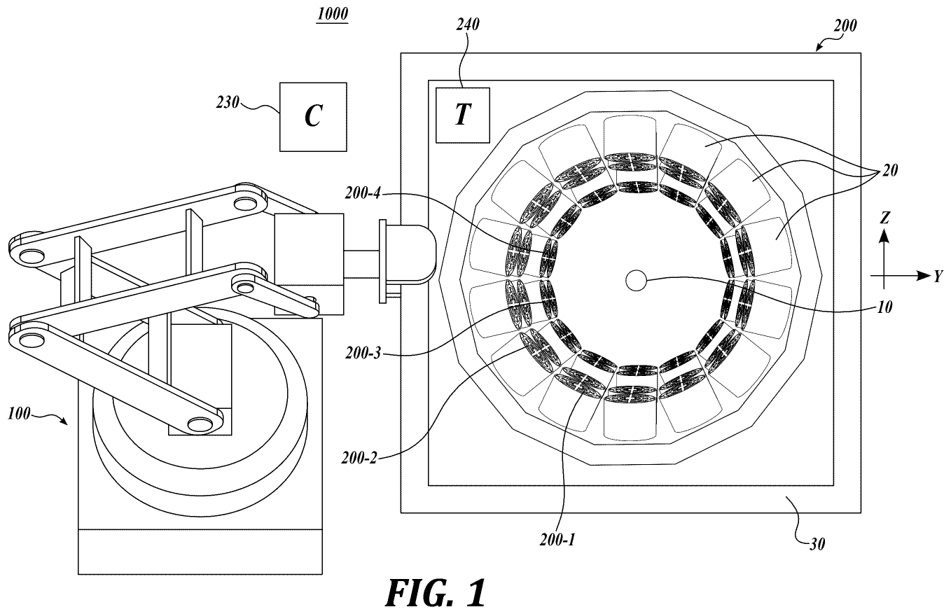

FIG. 1 is an isometric drawing of a system 1000 for weighing objects via ultrasonic levitation in accordance with an embodiment of the present technology. The illustrated system 1000 (also referred-to to as a system for a non-contact acoustic determination of a mass of an object) includes an ultrasound levitator (also referred to as an ultrasound manipulator or acoustic manipulator) 200 having four rows of ultrasound transducers: 200-1, 200-2, 200-3 and 200-4 (200-i for conciseness), each of which may include multiple ultrasound transducers 20. The ultrasound transducers are shown in the Y-Z plan view. In different embodiments, the ultrasound transducers may be arranged in a circular arrangement (illustrated in FIG. 1), a rectangular arrangement, or other arrangements. The rows 200-i of ultrasound transducers 20 may be held together by a frame 30.

In operation, the ultrasound transducers 20 emit ultrasound toward a target 10. In different embodiments, the targets 10 may be small and fragile objects 10 like insects, integrated circuit chips, flowers, drops of liquid, or other millimeter scale objects. These objects may be handled by the acoustic field generated by the transducers 20 without damaging the objects.

In some embodiments, mass determination system 1000 includes a mechanical manipulator 100. Some nonlimiting examples of the mechanical manipulator are a robotic arm or a movable stage. The mechanical manipulator 100 may assist in picking up an object, extracting visual features from the object, and performing object sorting based on the extracted features. In many embodiments, the system 1000 may provide an unblocked view of the entire object 10.

In some embodiments, operation of the acoustic manipulator 200 may be based on an acoustic field that optimizes the simulated force dynamics inside the acoustic manipulator 200. In different embodiments, the controller 230 may control frequencies, phases, relative phase delays and amplitudes of the signal sent to individual ultrasound transducers 20. The controller 230 may include suitable software and electronic components, for example, one or more processors and field programmable arrays (FPGAs). The controller 230 may also be tasked with accounting for object's mass and/or volume, for aggregating the objects into different groups, for sorting the objects based on their mass, etc., by, for example, saving the relevant data in a memory and/or repositioning the objects into different groups or object aggregations.

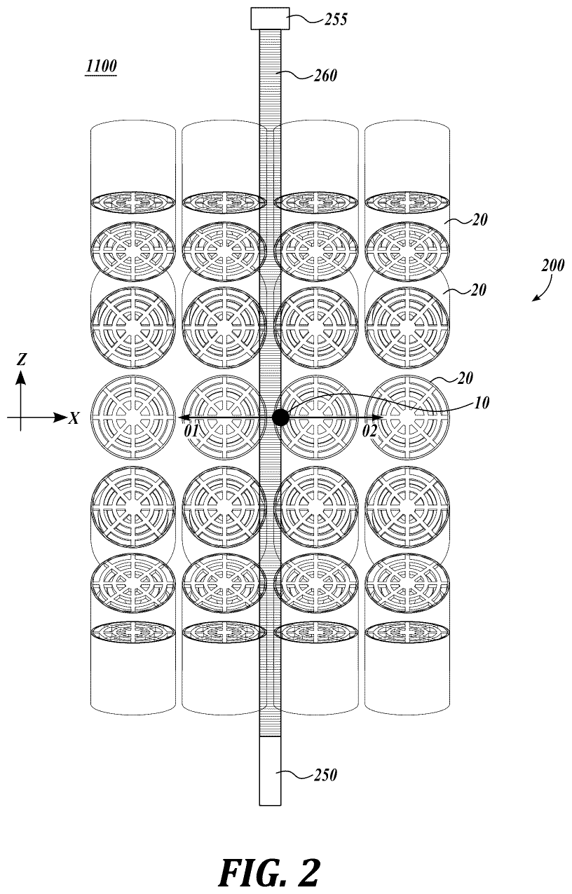

FIG. 2 is a cross-sectional side view of an acoustic balance 1100 in accordance with an embodiment of the present technology. The view is shown in the X-Z plane. The illustrated acoustic manipulator 200 also includes a source of light 250 (e.g., a laser diode, a light-emitting diode (LED)) and a displacement sensor 255 (e.g., a light sensor, a photoresistor, a camera, or an acoustic time of flight sensor). In operation, the source of light 250 emits a light beam 260 that is sensed by the displacement sensor 255. When the object 10 interrupts the light beam 260, the displacement sensor 255 can register the occlusion of the light beam 260, that is, the presence of the object 10 within the light beam 260 is detected. For example, the light beam 260 may travel through the gaps between the transducers 20 along the x=const. plane, while oscillation of the object 10 in the x direction intermittently occludes source of light 250 from the displacement sensor 255. Arrows O1 and O2 show directions of possible oscillation of the object 10.

In operation, object 10 is suspended in an acoustic trap created by the overall acoustic field generated by the transducers 20. Acoustic traps manipulate objects through pressure wave gradients. For example, the acoustic radiation force on a spherically shaped particle in air may be expressed as the gradient of the Gor'kov potential F_{rad}=−∇U, and other methods such as finite element analysis can be used to represent the acoustic force field for specific objects or known geometries. Acoustic levitation devices may manipulate objects by modulating air particles using ultrasonic waves. The ultrasonic waves create a spatially distributed, time average acoustic energy pattern. Objects inside the acoustic field will move from positions of high acoustic potential energy, to areas of low acoustic potential energy. Based on the ultrasound transducers used and the voltage applied to these transducers, the acoustic pressure and air velocity distribution can be determined.

A person of ordinary skill would understand that multi-channel, phase-controlled acoustic transducers 20 can manipulate and move objects through the air, overcoming gravity for relatively small and light objects. For example, if object 10 is suddenly moved from its equilibrium position within the acoustic field, the object is subjected to a restoring force that confines the object similar to a mass spring system. In operation, the inventive method may apply a step function perturbation to the position of the acoustic trap minimum and then observe the frequency of the object as it oscillates down to its new equilibrium position.

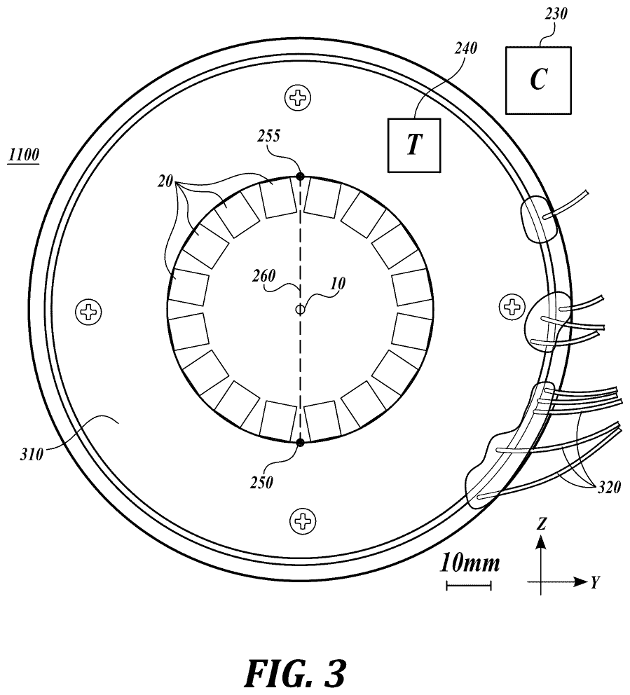

FIG. 3 is a top view of the acoustic balance 1100 shown in FIG. 2. That is, the view is shown in the Y-Z plane. In a nonlimiting example, the acoustic trap uses a 64 transducer, cylinder shaped geometry with 4 stacked rings of 16 transducers and a diameter of approximately 47.6 mm. Each transducer can be independently phase-controlled. An FPGA (Field Programmable Gate Array) sends time multiplexed output channel waveforms to shift registers which demultiplex each signal into 8 output channels. These output channels are then voltage level shifted from the 3.3V, 40 kHz, square waves to a 32V peak-to-peak square wave by a level shifting integrated circuit. Phase delay values for each transducer are calculated by a computer and sent to the FPGA via a serial connection. The acoustic trap is a standing wave levitator with opposing emitters, which restricts the maximum size of a trapped object to about 2.5 mm. By controlling the acoustic trap and performing the displacement maneuver with phase modulation rather than an acoustic emitter on-off method, multiple objects can potentially be levitated and controlled simultaneously with the acoustic weighing procedure.

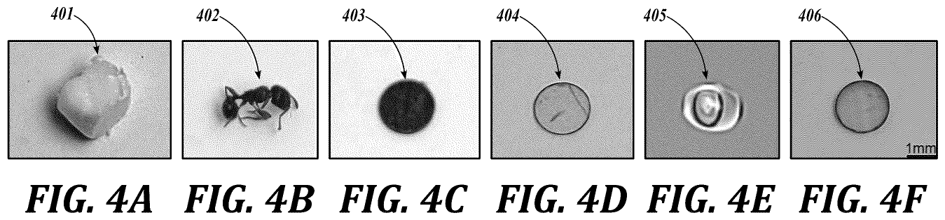

FIGS. 4A-4F are example objects subjected to weighing in accordance with embodiments of the present technology. Different objects 10 can be used as test masses to validate performance of the inventive mass determining ultrasound system. In particular, FIG. 4A shows a polystyrene particle, FIG. 4B shows an ant, FIG. 4C shows a hardfiber disk that is 5 mil thick, FIG. 4D shows a fiberglass-reinforced epoxy-laminated (FR4) disk 5 mil thick, FIG. 4E shows mineral oil droplet with air bubble trapped inside, and FIG. 4F shows FR4 disk that is 10 mil thick.

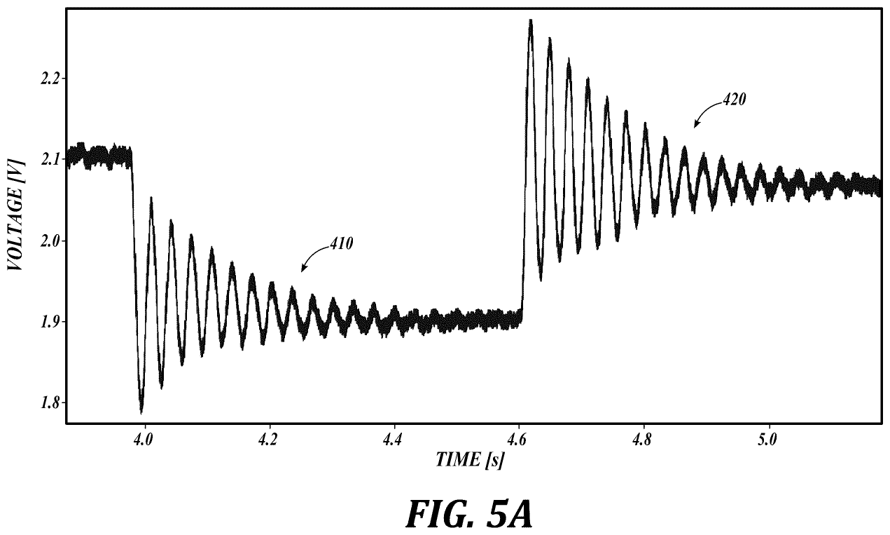

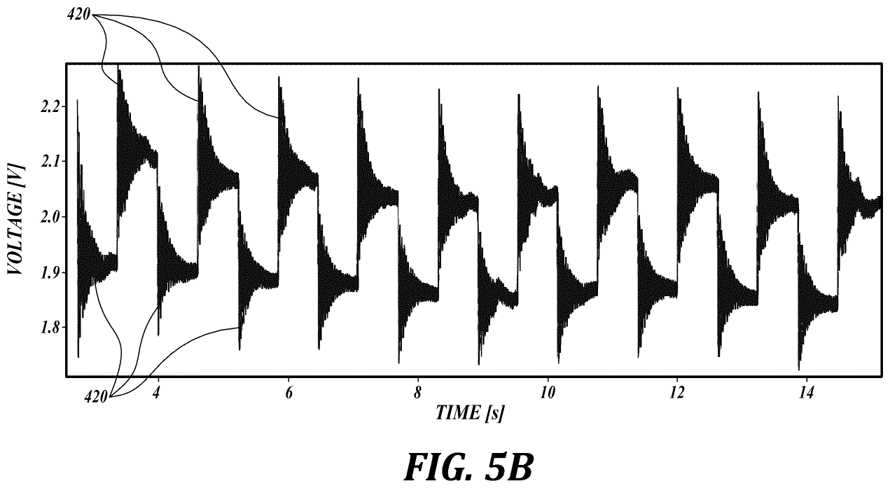

FIGS. 5A and 5B are graphs of object displacement in accordance with an embodiment of the present technology. The horizontal axis shows time in seconds, and the vertical axis shows a voltage of the displacement sensor 255, which scales with illumination of the sensor, therefore being a representative of the object 10 occluding or not occluding the light beam 260.

As an example, the laser beam 260 may be positioned on the x=20 mm plane and the object 10 may be positioned at x=21 mm, referred to as position 1. Next, the acoustic trap displaces the object, moving the object to x=20 mm, position 2, from its location at position 1. This 1 mm step allows for enough trapping discontinuity to cause the object to oscillate while remaining trapped within oscillations. Stated differently, a sudden displacement allows the system to quickly record the damped natural frequency to approximate the resonance frequency and calculate the object's mass using the force constant for the acoustic trap. The movement phase from position 1 to position 2 is called the primary displacement. After the object has stopped oscillating, a secondary displacement can be performed, moving the object from position 2 back to position 1. The total time to measure a single object is in the illustrated example is about 2 seconds for both positions.

As explained above, the object suspended in the acoustic trap is subjected to a restoring force that confines the object similar to a mass spring system. Omitting the viscous damping forces, the confining force on the object can be linearly approximated by the equation:

$$m \frac{d 2 x}{{dt}^{2}} + kx = 0 \qquad Eq . ( 1 )$$

where k is the restoring force constant, and x is the horizontal displacement.

The relationship between the object's mass m and resonance frequency f can be described by the expression for the natural frequency of a harmonic oscillator:

$$m = \frac{k}{{( 2 π f )}^{2}} \qquad Eq . ( 2 )$$

In some embodiments, an object 10 of a known mass can be used determine the value of k from eq. (1). Subsequently, mass of a same type of object can be determined based on eq. (2), as further explained below. Stated differently, a suitable calibration mass is one that is similar in shape and material composition as the subsequently weighed objects. This approach reduces potential calibration related weighing error attributed to object shape and material properties. A person of ordinary skill would understand that the same or similar type of object being used for determining the value of k from eq. (1) and a mass of the object based on eq. (2) improve accuracy of the measurements, because the viscous damping should be similar for the calibration and the measurement phases, thus justifying using a simplified eq. (1) above (to the exclusion of the viscous damping term).

A person of ordinary skill would know that the value of frequency f from eq. (2) can be determined by, for example, running a Fourier transform over the time series shown in FIG. 5A or 5B. In a non-limiting example measurement, the oscillation frequency of the levitated object is measured using a 3 mm beam diameter 650 nm laser diode and a 10 kΩto 200 kΩphotoresistor with a detection window of 4 mm×3 mm, with the levitated object positioned partially occluding the beam. The variable resistance of the photoresistor can be converted to a variable voltage by a voltage divider circuit. The voltage signal shown in FIGS. 5A and 5B may be recorded by a digitizer configured to sample at 2.5 mega-samples per second (MSps), which is a much higher sampling rate than a camera.

In some embodiments, a sensor measures the ambient air temperature in the acoustic balance and the model used to calculate the phase angles controlling the acoustic emitters is adjusted. This helps to ensure acoustic pressure field consistency between weighing attempts since the speed of sound in air is proportional to the square root of temperature in Kelvin. Factors that influence the acoustic pressure field, such as acoustic emitter driving voltage or the number of transducers used to form the acoustic pressure field, may be kept consistent after calibration.

Another factor that may influence the effectiveness of acoustic weighing (i.e., determination of mass) is the settling time of the object after being displaced. FIG. 5A shows how the oscillations of the first response are damped out before the secondary displacement occurs at t=4.6 s. The settling time is the time the object takes to reach steady state after it has been perturbed. This also determines the rate in which subsequent measurements can be made. For objects with greater air resistance, the settling time can be even less as the oscillations are damped out quicker. An embodiment of calibration of the mass determining system is discussed with respect to FIG. 5B below.

FIG. 5B is a graph of object displacement in accordance with an embodiment of the present technology. The horizontal axis shows time in seconds, and the vertical axis shows a voltage of the displacement sensor 255. In some embodiments, to calibrate the balance, the reference object is acoustically weighed 10 times to obtain a mean natural frequency f, for a total of 200 frequency samples. The mean damped natural frequency from the displacement sensor and the directly measured mass from the XPR2U were then used to compute the linear force coefficient, k, for each calibration mass. Table A below shows the directly measured mass values obtained during the calibration procedure.

TABLE A
Calibration Masses

| | Mass |
|---|---|
| Calibration Object | (mg) |
| Polystyrene | 0.255 |
| Ant | 0.173 |
| Hardfiber Disk | 0.437 |
| FR4 5 mil Disk | 0.582 |
| Mineral Oil | 0.863 |
| FR4 10 mil Disk | 1.527 |

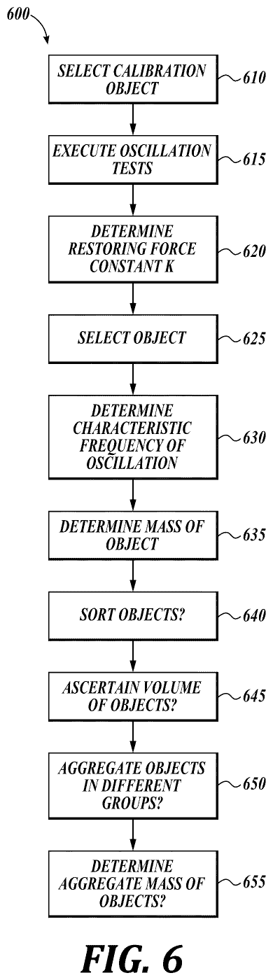

FIG. 6 is a flowchart 600 of a method for non-contact determination of mass of objects in accordance with an embodiment of the present technology. In some embodiments, the method may include additional steps or may be practiced without all steps illustrated in the flow chart.

In block 610, a calibration object is selected. As explained above, the calibration object should be an object of known mass and should have material and shape properties that are comparable to those of the objects that will be weighed after the calibration phase.

In block 615, oscillation tests are performed using the acoustic manipulator 200. The oscillation tests may rely on a change in the phase of the acoustic emitters, which results in a sudden change in the equilibrium position of the trap, which, in turn, causes the object 10 to oscillate at its natural frequency of oscillation. The oscillation of the calibration object can be captured using the light sensor 255. Examples of such oscillation of the calibration object are shown in FIGS. 5A and 5B above.

In block 620, the restoring force constant k can be determined based on eq. (1) and the data obtained in block 615.

In block 625, an object 10 may be selected for which the mass is to be determined. As explained above, a choice of the calibration object 610 is informed by the properties (e.g., size, type of material, shape, etc.) of the object 10. Nonlimiting examples of such objects are insects, integrated circuit chips, flowers, drops of liquid, or other millimeter scale objects.

In block 630, a characteristic frequency of oscillation is determined by first running an oscillation test through a sudden change in the equilibrium position of the trap for the object 10. In different embodiments, different numbers of oscillation tests can be performed. In some embodiments, up to 20 consecutive tests may be performed in two positions of the object 10 (e.g., two equilibrium position of the trap). The characteristic frequency f of the oscillation of object 10 can be determined by, for example, running a Fourier transform on the time series of oscillation obtained through the light sensor 255.

In block 635, a mass of the object can be determined based on the eq. (2), where the restoring force constant k has been earlier determined from eq. (1) and the characteristic frequency f of the oscillation of object 10 has been determined in block 630.

In block 640, the objects 10 may be sorted. For example, the method may include mass-based sorting that support dispensing of precise quantities of material from dispensers in applications like automated laboratory processes and additive manufacturing. These techniques can be applied to the development of robot manipulated tools or end effectors, therefore possibly enabling a general purpose robot to perform precise chemical or biological sample mixing tasks. For example, weighing the object 10 can allow a robot to collect mass data about an individual sample and automate tasks such as sorting, modifying, or adding additional solution to a liquid droplet.

In block 645, volume of the objects 10 may be determined. Such a determination may be based on a known density of the object 10 and a measured mass from block 635. For example, mass of a liquid droplet that is dispensed from a dispenser can be determined.

In block 650, objects 10 may be aggregated into different groups. For example, aggregation may be performed into different bins (categories) by the mass of objects 10. In some applications, different mass may be related to different type of objects, making aggregation especially useful. For example, a mixture of objects may include droplets of water and droplets of oil. If the mass of individual water droplets is different from the mass of individual oil droplets, the objects (water and oil droplets) may be aggregated into separate groups by the inventive technology.

In block 655, an aggregate mass of objects may be determined. For example, masses of the individual objects can be summed for the objects that were aggregated into different groups in block 650. In some embodiments, the aggregate mass of the objects can be determined in real time during aggregation of the objects. For example, masses of individual objects can be determined, followed by aggregating the objects in different groups based on the mass of the individual objects and determining whether a target cumulative mass for such plurality of aggregated objects has been achieved.

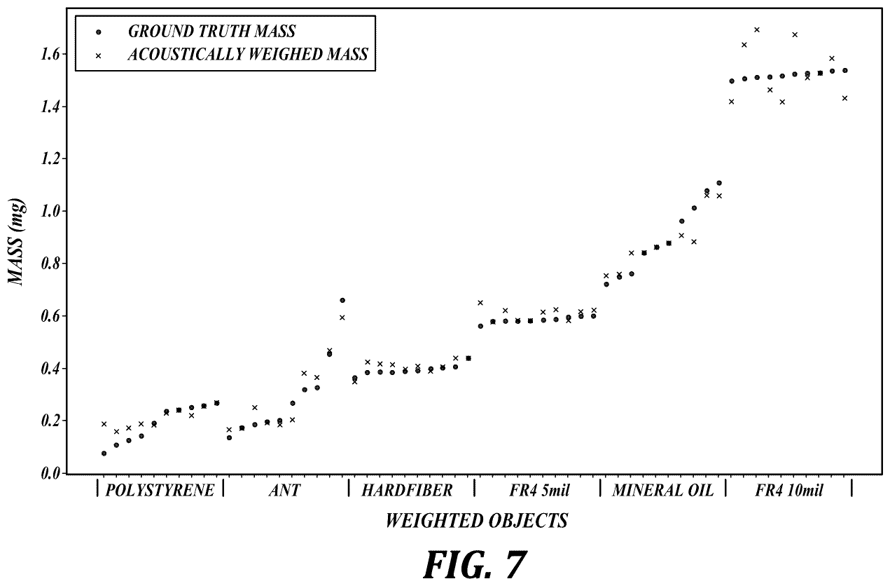

FIG. 7 is a graph of object mass determined in accordance with an embodiment of the present technology. The horizontal axis shows different objects being weighed using the acoustic manipulator 200. The vertical axis shows the mass of the different objects. Two sets of data are shown for each type of the object: ground truth mass and the results of measurements using the acoustic manipulator 200. As the test object mass drops below 0.2 mg, the measurement error increases. Considering the test object group with the greatest mass, the FR4 10 mil data has the largest absolute mass variance relative to the other samples, even of similar shape and percent error. Combined with the low frequency standard deviation at 2.91%, the FR4 10 mil thickness test object likely has the lowest linear force coefficient compared to the other test masses. This indicates that, for the illustrated embodiment, the FR4 10 mil disk may signify an upper limit of mass that the levitation system is capable of sufficiently trapping and weighing. Therefore, in at least some embodiments, the range of relatively accurate measurement for this specific acoustic levitation device is between 1.5 mg and 0.2 mg. However, in different embodiments of inventive technology such ranges of practical applicability may be different.

From the foregoing, it will be appreciated that specific embodiments of the technology have been described herein for purposes of illustration, but that various modifications may be made without deviating from the disclosure. Moreover, while various advantages and features associated with certain embodiments have been described above in the context of those embodiments, other embodiments may also exhibit such advantages and/or features, and not all embodiments need necessarily exhibit such advantages and/or features to fall within the scope of the technology. Accordingly, the disclosure can encompass other embodiments not expressly shown or described herein.

What is claimed is:

1. A method for a non-contact acoustic determination of a mass of an object, comprising:
capturing the object within an acoustic trap of an acoustic balance;
in response to changing at least one acoustic parameter of the acoustic balance, changing an equilibrium position of the object;
in response to changing the equilibrium position of the object, causing the object to oscillate;
determining a resonant frequency of oscillation of the object; and
based on the resonant frequency of oscillation of the object, determining the mass of the object.

2. The method of claim 1, wherein the at least one acoustic parameter is a phase of ultrasound generated by at least one transducer of the acoustic balance.

3. The method of claim 1, wherein the acoustic trap is an acoustic wave levitator generated by opposing transducers of the acoustic balance.

4. The method of claim 1, wherein changing the equilibrium position of the object is a discontinuous changing of the equilibrium position of the object.

5. The method of claim 4, further comprising using two positions of the object within the acoustic balance for determining the mass of the object.

6. The method of claim 5, wherein the resonant frequency of the object determined using a laser-based displacement sensor, a camera, or acoustic time of flight sensors.

7. The method of claim 1, wherein the mass of the object is determined as:
$$m = \frac{k}{{( 2 \prod f )}^{2}}$$
where:
m is the mass of the object,
f is the resonant frequency of the object, and
k is a restoring force constant.

8. The method of claim 1, further comprising:
calibrating the acoustic balance by acoustically weighing at least one reference object of a known mass.

9. The method of claim 8, further comprising determining a restoring force constant k of the object based on acoustically weighing the at least one reference object of the known mass.

10. The method of claim 1, further comprising:
sorting objects based on the mass of individual objects.

11. The method of claim 1, further comprising:
ascertaining a volume of at least one liquid droplet by determining a mass of the at least one liquid droplet, wherein the at least one liquid droplet is dispensed from a dispenser.

12. The method of claim 1, further comprising:
aggregating objects in different groups based on the mass of individual objects.

13. The method of claim 11, further comprising:
determining aggregate mass of the objects in real time during aggregating the objects.

14. The method of claim 1, further comprising:
weighing individual objects;
aggregating the individual objects into different groups based on the mass of the individual objects of a plurality of objects; and
determining whether a target cumulative mass for the plurality of objects is achieved.

15. An apparatus for a non-contact acoustic determination of a mass of an object, comprising:
an array of ultrasound transducers configured for generating an ultrasound field; and
a controller configured to generate phase delay signals for the array of ultrasound transducers;
wherein the ultrasound field is configured for:
capturing the object within an acoustic trap of an acoustic balance;
in response to changing at least one acoustic parameter of the acoustic balance, changing an equilibrium position of the object; and
in response to changing the equilibrium position of the object, causing the object to oscillate,
wherein the controller is configured for:
determining a resonant frequency of oscillation of the object; and
based on the resonant frequency of oscillation of the object, determining the mass of the object.

16. The apparatus of claim 15, wherein the at least one acoustic parameter is a phase of ultrasound generated by at least one transducer of the acoustic balance.

17. The apparatus of claim 15, wherein an oscillation of the object is a damped oscillation.

18. The apparatus of claim 15, wherein the resonant frequency of the object is determined using a laser-based displacement sensor, a camera, or acoustic time of flight sensors.

19. The apparatus of claim 15, wherein the mass of the object is determined as:
$$m = \frac{k}{{( 2 \prod f )}^{2}}$$
where:
m is the mass of the object,
f is the resonant frequency of the object, and
k is a restoring force constant.

20. The apparatus of claim 15, wherein the controller is further comprised for:
calibrating the acoustic balance by acoustically weighing at least one reference object of a known mass.

21. The apparatus of claim 15, wherein the controller is further comprised for:
sorting objects based on the mass of individual objects.

22. The apparatus of claim 15, wherein the controller is further comprised for:
aggregating objects in different groups based on the mass of individual objects.

23. The apparatus of claim 15, wherein the controller is further comprised for:
determining a target cumulative mass for a plurality of objects;
weighing individual objects;
aggregating the objects in different groups based on mass of the individual objects; and
determining aggregate mass of the objects in real time during aggregating the objects.
